(19) United States
(12) Patent Application Publication
(10) Pub. No.: US 2024/0097778 A1
(43) Pub. Date: Mar. 21, 2024

(54) OPPORTUNISTIC SATELLITE COMMUNICATION WITH ALIGNMENT PREDICTION

(71) Applicant: QUALCOMM Incorporated, San Diego, CA (US)

(72) Inventors: Junsheng HAN, Los Altos Hills, CA (US); Kannan MUTHURAMAN, Mission Viejo, CA (US); Francesco GRILLI, La Jolla, CA (US); Jonathan KIES, Encinitas, CA (US); Bala RAMASAMY, San Marcos, CA (US); Danlu ZHANG, San Diego, CA (US)

(21) Appl. No.: 18/466,733

(22) Filed: Sep. 13, 2023

Related U.S. Application Data
(60) Provisional application No. 63/375,767, filed on Sep. 15, 2022.

(51) Int. Cl. H04B 7/185

(52) U.S. Cl. CPC H04B 7/18519; H04B 7/18513

(57) ABSTRACT

Disclosed are techniques for wireless communication. In an aspect, a wireless communication device detects a trigger to transmit a message via satellite connectivity, determines one or more alignment opportunities associated with one or more satellites, wherein each alignment opportunity of the one or more alignment opportunities is a time period during which a main lobe of an antenna of the wireless communication device is predicted to be aligned with a line-of-sight (LOS) direction to at least one satellite of the one or more satellites, transitions to a sleep state until at least one alignment opportunity of the one or more alignment opportunities, and transmits the message to the at least one satellite of the one or more satellites during the at least one alignment opportunity of the one or more alignment opportunities.

### CROSS-REFERENCE TO RELATED APPLICATIONS

The present application for patent claims the benefit of U.S. Provisional Application No. 63/375,767, entitled “OPPORTUNISTIC SATELLITE COMMUNICATION WITH ALIGNMENT PREDICTION,” filed Sep. 15, 2022, assigned to the assignee hereof, and expressly incorporated herein by reference in its entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a wireless communication device includes detecting a trigger to communicate via satellite connectivity; determining one or more alignment opportunities associated with one or more satellites, wherein each alignment opportunity of the one or more alignment opportunities is a time period during which a main lobe of at least one antenna of one or more antennas of the wireless communication device is predicted to be aligned with a line-of-sight (LOS) direction to at least one of the one or more satellites; refraining from communicating with the one or more satellites until at least one alignment opportunity of the one or more alignment opportunities; and communicating with at least one satellite of the one or more satellites during the at least one alignment opportunity of the one or more alignment opportunities.

In an aspect, a wireless communication device includes one or more memories; one or more transceivers; and one or more processors communicatively coupled to the one or more memories and the one or more transceivers, the one or more processors, either alone or in combination, configured to: detect a trigger to communicate via satellite connectivity; determine one or more alignment opportunities associated with one or more satellites, wherein each alignment opportunity of the one or more alignment opportunities is a time period during which a main lobe of at least one antenna of one or more antennas of the wireless communication device is predicted to be aligned with a line-of-sight (LOS) direction to at least one of the one or more satellites; refrain from communicating with the one or more satellites until at least one alignment opportunity of the one or more alignment opportunities; and communicate, via the one or more transceivers, with at least one satellite of the one or more satellites during the at least one alignment opportunity of the one or more alignment opportunities.

In an aspect, a wireless communication device includes means for detecting a trigger to communicate via satellite connectivity; means for determining one or more alignment opportunities associated with one or more satellites, wherein each alignment opportunity of the one or more alignment opportunities is a time period during which a main lobe of at least one antenna of one or more antennas of the wireless communication device is predicted to be aligned with a line-of-sight (LOS) direction to at least one of the one or more satellites; means for refraining from communicating with the one or more satellites until at least one alignment opportunity of the one or more alignment opportunities; and means for communicating with at least one satellite of the one or more satellites during the at least one alignment opportunity of the one or more alignment opportunities.

In an aspect, a non-transitory computer-readable medium stores computer-executable instructions that, when executed by a wireless communication device, cause the wireless communication device to: detect a trigger to communicate via satellite connectivity; determine one or more alignment opportunities associated with one or more satellites, wherein each alignment opportunity of the one or more alignment opportunities is a time period during which a main lobe of at least one antenna of one or more antennas of the wireless communication device is predicted to be aligned with a line-of-sight (LOS) direction to at least one of the one or more satellites; refrain from communicating with the one or more satellites until at least one alignment opportunity of the one or more alignment opportunities; and communicate with at least one satellite of the one or more satellites during the at least one alignment opportunity of the one or more alignment opportunities.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIG. 3 is a simplified block diagrams of several sample aspects of components that may be employed in a user equipment (UE) and configured to support communications as taught herein.

FIG. 4 is a diagram illustrating an emergency message via satellite scenario in which the user is orienting a mobile device towards a satellite, according to aspects of the disclosure.

FIG. 5 is a diagram illustrating an Internet of Things (IoT) over non-terrestrial network (NTN) scenario, according to aspects of the disclosure.

FIG. 6 illustrates two example sky plots of the trajectories of Iridium NEXT satellites as viewed from San Diego, California, according to aspects of the disclosure.

FIG. 7 illustrates an example sky plot of the trajectories of Iridium NEXT satellites as viewed by a device in San Diego, California, according to aspects of the disclosure.

FIG. 8 illustrates an example of the maximum alignment error for Iridium NEXT satellites as viewed from an observation point on the Equator, according to aspects of the disclosure.

FIG. 9 illustrates an example sky plot of the trajectories of Iridium NEXT satellites as viewed by a device in San Diego, California, according to aspects of the disclosure.

FIG. 10 is an example method of aligning a device's main antenna lobe with the line-of-sight (LOS) direction to a satellite, according to aspects of the disclosure.

FIG. 11 illustrates an example method of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to satellite communication. Some aspects more specifically relate to opportunistic satellite communication with alignment prediction. In some examples, for wireless communication devices that lack antennas with sufficient directionality, the wireless communication device determines relative locations of the wireless communication device and one or more satellites and determines the next opportunity to transmit (or receive) on the basis of the relative locations and the path(s) of the satellite(s). A user interface (UI) element asks the user to place the wireless communication device in a certain manner on a surface for a given period of time, and the wireless communication device transmits (or receives) the message at the future time when alignment with at least one satellite is achieved.

Particular aspects of the subject matter described in this disclosure can be implemented to realize one or more of the following potential advantages. In some examples, by determining the next transmission (or reception) opportunity and waiting until that opportunity to transmit (or receive), the described techniques can be used to reduce power consumption, reduce the bill of materials (BOM) of the wireless communication device, and increase the likelihood of successfully communicating with a satellite, especially when the wireless communication device cannot be moved, or the user is not able to follow an interactive pointing procedure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

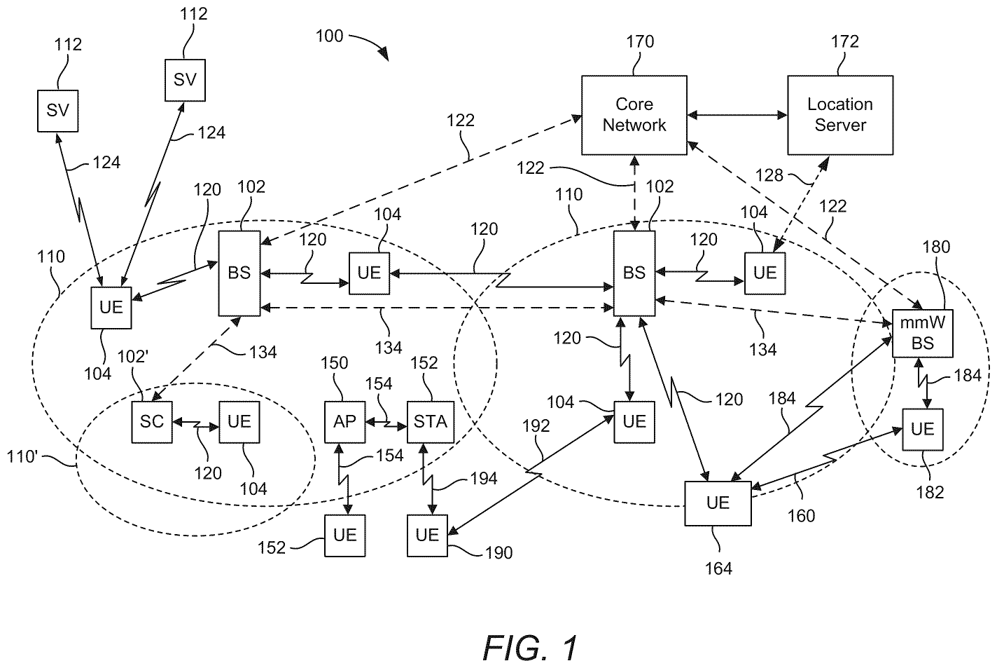

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

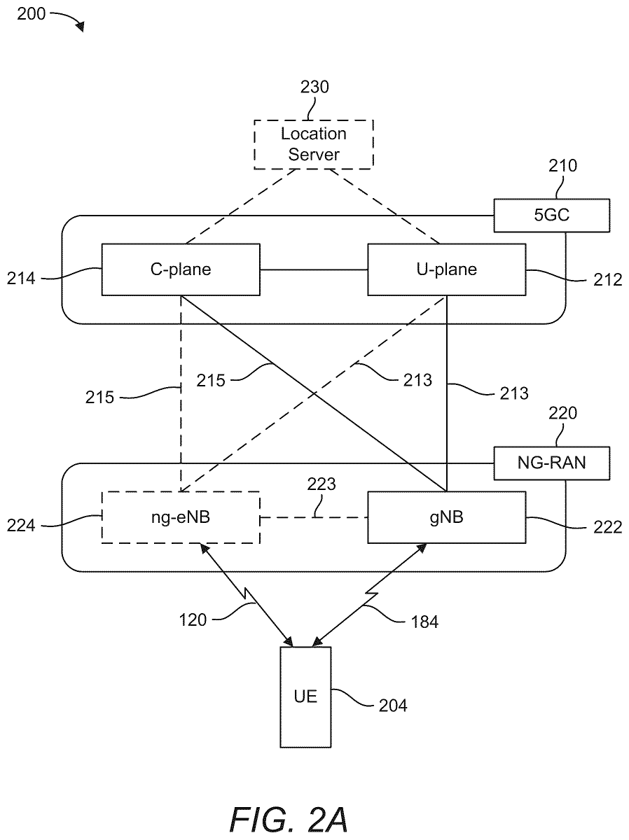

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

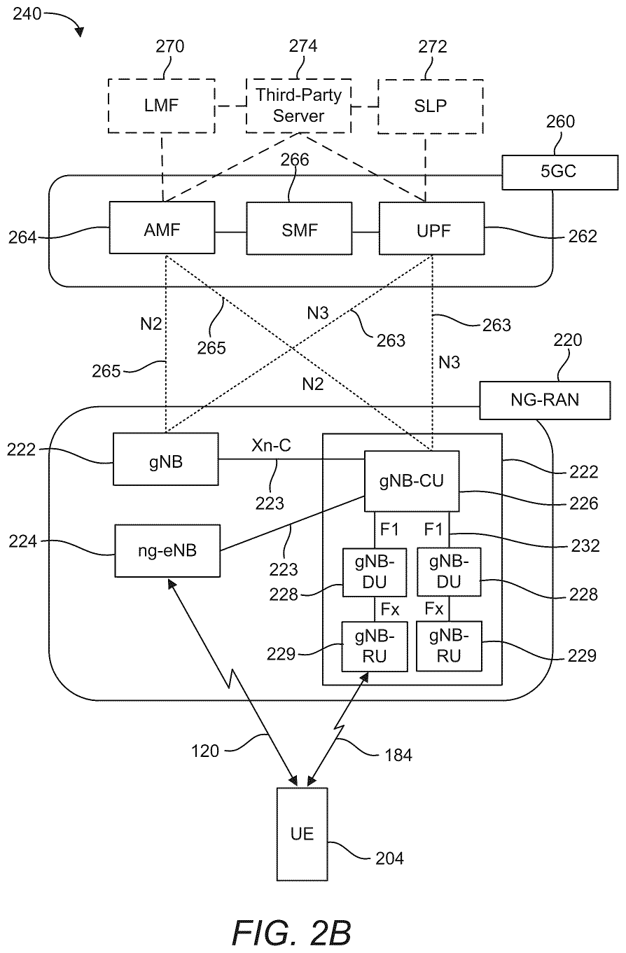

FIG. 3 illustrates several example components (represented by corresponding blocks) that may be incorporated into a UE 302 (which may correspond to any of the UEs described herein). It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 includes one or more wireless wide area network (WWAN) transceivers 310 providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The one or more WWAN transceivers 310 may each be connected to one or more antennas 316 for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The one or more WWAN transceivers 310 may be variously configured for transmitting and encoding signals 318 (e.g., messages, indications, information, and so on) and, conversely, for receiving and decoding signals 318 (e.g., messages, indications, information, pilots, and so on) in accordance with the designated RAT. Specifically, the one or more WWAN transceivers 310 include one or more transmitters 314 for transmitting and encoding signals 318 and one or more receivers 312 for receiving and decoding signals 318.

The UE 302 also includes, at least in some cases, one or more short-range wireless transceivers 320. The one or more short-range wireless transceivers 320 may be connected to one or more antennas 326 and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The one or more short-range wireless transceivers 320 may be variously configured for transmitting and encoding signals 328 (e.g., messages, indications, information, and so on) and, conversely, for receiving and decoding signals 328 (e.g., messages, indications, information, pilots, and so on) in accordance with the designated RAT. Specifically, the one or more short-range wireless transceivers 320 include one or more transmitters 324 for transmitting and encoding signals 328 and one or more receivers 322 for receiving and decoding signals 328. As specific examples, the one or more short-range wireless transceivers 320 may be Wi-Fi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 also includes, at least in some cases, a satellite signal interface 330, which includes one or more satellite signal receivers 332 and may optionally include one or more satellite signal transmitters 334. The one or more satellite signal receivers 332 may be connected to one or more antennas 336 and may provide means for receiving and/or measuring satellite positioning/communication signals 338. Where the one or more satellite signal receivers 332 include a satellite positioning system receiver, the satellite positioning/communication signals 338 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the one or more satellite signal receivers 332 include a non-terrestrial network (NTN) receiver, the satellite positioning/communication signals 338 may be communication signals (e.g., carrying control and/or user data) originating from a 5G network. The one or more satellite signal receivers 332 may comprise any suitable hardware and/or software for receiving and processing satellite positioning/communication signals 338. The one or more satellite signal receivers 332 may request information and operations as appropriate from the other systems, and, at least in some cases, perform calculations to determine locations of the UE 302 using measurements obtained by any suitable satellite positioning system algorithm.

The optional satellite signal transmitter(s) 334, when present, may be connected to the one or more antennas 336 and may provide means for transmitting satellite positioning/communication signals 338. Where the one or more satellite signal transmitters 334 include an NTN transmitter, the satellite positioning/communication signals 338 may be communication signals (e.g., carrying control and/or user data) originating from a 5G network. The one or more satellite signal transmitters 334 may comprise any suitable hardware and/or software for transmitting satellite positioning/communication signals 338. The one or more satellite signal transmitters 334 may request information and operations as appropriate from the other systems.

A transceiver may be configured to communicate over a wired or wireless link. A transceiver (whether a wired transceiver or a wireless transceiver) includes transmitter circuitry (e.g., transmitters 314, 324) and receiver circuitry (e.g., receivers 312, 322). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver may be coupled to one or more wired network interface ports. Wireless transmitter circuitry (e.g., transmitters 314, 324) may include or be coupled to a plurality of antennas (e.g., antennas 316, 326), such as an antenna array, that permits the respective apparatus (e.g., UE 302) to perform transmit “beamforming,” as described herein. Similarly, wireless receiver circuitry (e.g., receivers 312, 322) may include or be coupled to a plurality of antennas (e.g., antennas 316, 326), such as an antenna array, that permits the respective apparatus (e.g., UE 302) to perform receive beamforming, as described herein. In an aspect, the transmitter circuitry and receiver circuitry may share the same plurality of antennas (e.g., antennas 316, 326), such that the respective apparatus can only receive or transmit at a given time, not both at the same time. A wireless transceiver (e.g., the one or more WWAN transceivers 310, the one or more short-range wireless transceivers 320) may also include a network listen module (NLM) or the like for performing various measurements.

As used herein, the various wireless transceivers (e.g., transceivers 310, 320) and wired transceivers may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station will generally relate to signaling via a wireless transceiver.

The UE 302 also includes other components that may be used in conjunction with the operations as disclosed herein. The UE 302 includes one or more processors 342 for providing functionality relating to, for example, wireless communication, and for providing other processing functionality. The one or more processors 342 may therefore provide means for processing, such as means for determining, means for calculating, means for receiving, means for transmitting, means for indicating, etc. In an aspect, the one or more processors 342 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302 includes memory circuitry implementing memory 340 (e.g., each including a memory device) for maintaining information (e.g., information indicative of reserved resources, thresholds, parameters, and so on). The memory 340 may therefore provide means for storing, means for retrieving, means for maintaining, etc. In some cases, the UE 302 may include a alignment component 348. The alignment component 348 may be hardware circuits that are part of or coupled to the one or more processors 342 that, when executed, cause the UE 302 to perform the functionality described herein. In other aspects, the alignment component 348 may be external to the processors 342 (e.g., part of a modem processing system, integrated with another processing system, etc.). Alternatively, the alignment component 348 may be a memory module stored in the memory 340 that, when executed by the one or more processors 342 (or a modem processing system, another processing system, etc.), cause the UE 302 to perform the functionality described herein. FIG. 3 illustrates possible locations of the alignment component 348, which may be, for example, part of the one or more WWAN transceivers 310, the memory 340, the one or more processors 342, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

The various components of the UE 302 may be communicatively coupled to each other over a data bus 308. In an aspect, the data bus 308 may form, or be part of, a communication interface of the UE 302.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on).

For convenience, the UE 302 is shown in FIG. 3 as including various components that may be configured according to the various examples described herein. It will be appreciated, however, that the illustrated components may have different functionality in different designs. In particular, various components in FIG. 3 are optional in alternative configurations and the various aspects include configurations that may vary due to design choice, costs, use of the device, or other considerations. For example, a particular implementation of UE 302 may omit the WWAN transceiver(s) 310 (e.g., a wearable device or tablet computer or PC or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. For brevity, illustration of the various alternative configurations is not provided herein, but would be readily understandable to one skilled in the art.

The components of FIG. 3 may be implemented in various ways. In some implementations, the components of FIG. 3 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 308 to 346 may be implemented by processor and memory component(s) of the UE 302 (e.g., by execution of appropriate code and/or by appropriate configuration of processor components). For simplicity, various operations, acts, and/or functions are described herein as being performed “by a UE.” However, as will be appreciated, such operations, acts, and/or functions may actually be performed by specific components or combinations of components of the UE 302, such as the one or more processors 342, the one or more transceivers 310 and 320, the memory 340, the alignment component 348, etc.

In satellite communication scenarios, it is important to align the main antenna lobe (or main beam) of the wireless user device with the line-of-sight (LOS) direction to the satellite due to the generally lower transmit power capabilities of the wireless user device and large path loss. For example, some wireless user devices provide an emergency satellite connectivity feature that gives users the ability to send emergency (SOS) messages via satellite. Because user devices generally have lower transmit power capabilities, sending an SOS message via satellite generally requires an unobstructed path to the satellite. Orienting the device so that the main antenna lobe is aligned with the LOS direction to the satellite is therefore very important to meet the link budget (i.e., the transmit power necessary for the emergency signal to be received at the satellite with acceptable signal-to-noise ratio (SNR)).

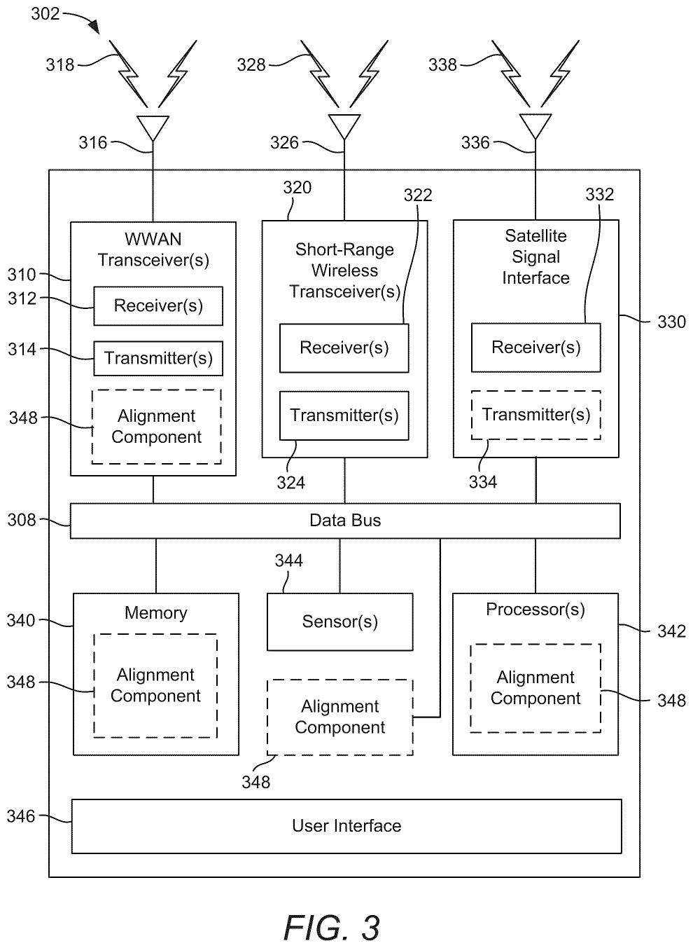

FIG. 4 is a diagram 400 illustrating an emergency message via satellite scenario in which the user is orienting a mobile device towards a satellite, according to aspects of the disclosure. As shown, by orienting the device towards the satellite, the main antenna lobe is aligned with the LOS direction to the satellite. It would be beneficial to have a user-friendly, robust, and smart method to assist a user to align the mobile device with the satellite.

As another example, NTN connectivity is a feature of 5G NR and is important for service continuity. In this case, link budget and UE power consumption concerns, as well as the frequency bands used for NTN services, make beamforming at the UE challenging. As such, orienting the UE so that its antenna lobe is aligned with the direction of the satellite is highly desirable. Doing so can save power and reduce the bill of materials (BOM) (resulting in savings in the costs of the amplifier, antenna, etc.), for example.

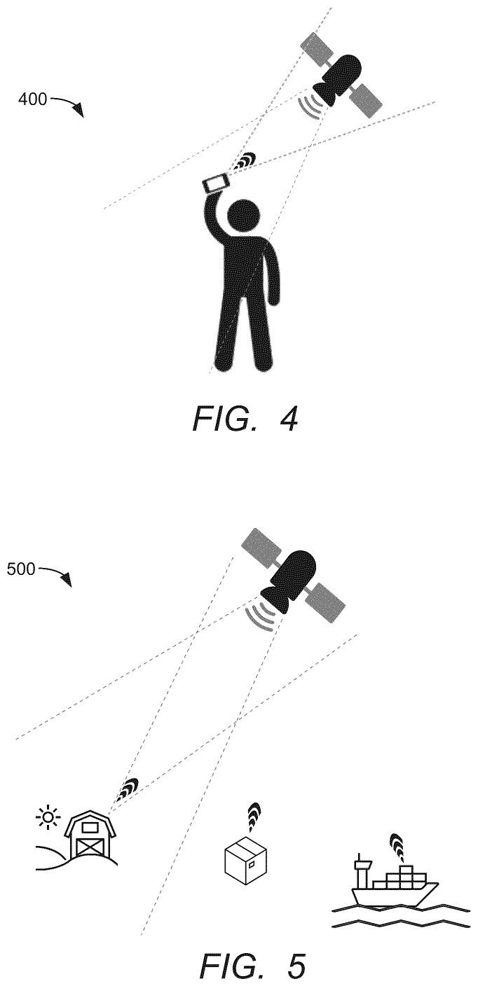

FIG. 5 is a diagram 500 illustrating an IoT over NTN scenario, according to aspects of the disclosure. As shown in FIG. 5, various IoT devices are deployed in remote areas where cellular coverage may not be available. Further, in many IoT applications, the UE is affixed to an object that is not moveable or unable to be moved for a certain duration (e.g., package). As such, to provide improved NTN connectivity and reduced power consumption, it would be beneficial to be able to improve antenna alignment without physically re-orienting the UE.

Existing solutions for improving antenna alignment focus on interactive procedures requiring the user to physically reorient the device to achieve antenna-to-satellite alignment. However, in an emergency situation, for example, the user may be in a distressed situation and may therefore be incapable of following the interactive user interface (UI) prompts. For example, the user may be disabled, vision impaired, injured, sick, exhausted, constrained in motion, experiencing hand tremors, subject to extreme weather, etc. In these scenarios, being able to send an SOS message could mean life or death to the user.

Over time, satellites can have good coverage of the whole sky. For example, the orbital plane of Iridium NEXT satellites (a type of communication satellite) sweeps the whole sky in approximately two hours. These satellites travel in six North-South orbital planes. As Earth rotates eastward, an orbital plane on the east with respect to a given user location will gradually move west. The orbital planes are spaced by approximately 31.6 degrees. Since the Earth rotates at about 15 degrees per hour, the satellites will traverse the whole sky in about 2.1 hours.

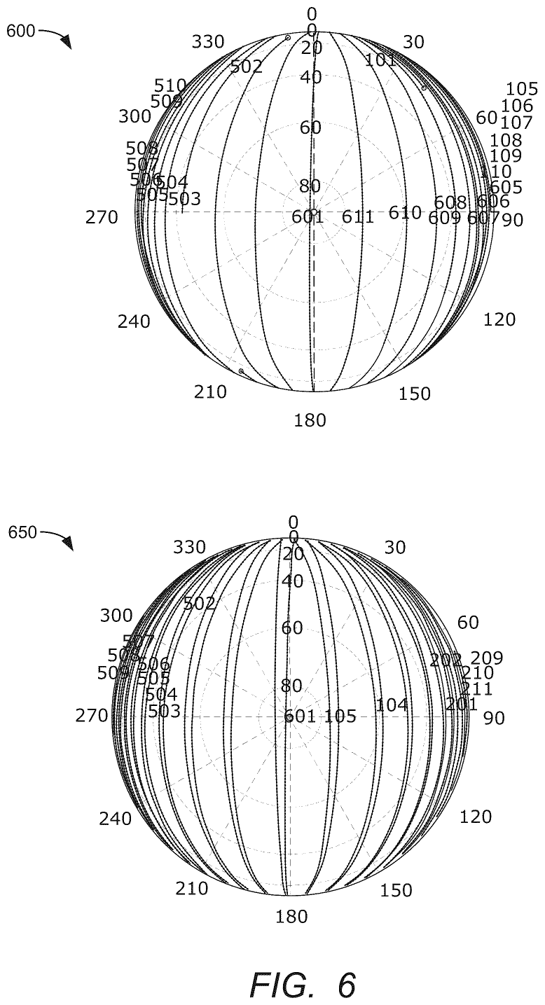

FIG. 6 illustrates two example sky plots of the trajectories of Iridium NEXT satellites as viewed from San Diego, California, according to aspects of the disclosure. A sky plot represents the locations and movement of heavenly bodies relative to an observation point on Earth (e.g., San Diego). More specifically, the center of the circle corresponds to the observation point (e.g., a user, a device, a city center, etc.). Azimuth angles relative to the observation point are represented as lines radiating out from the center. For example, North from the observation point is 0 degrees, South is 180 degrees, and so on. Elevation angles relative to the observation point are represented as concentric circles around the center. The outside circle represents the horizon at 0 degrees, and the elevation angles increase to 90 degrees (i.e., straight up from the observation point) at the center.

Referring back to the example of FIG. 6, sky plot 600 illustrates the trajectories of Iridium NEXT satellites over two hours, while sky plot 650 illustrates their trajectories over four hours. As can be seen, in sky plot 650, the locations over the Earth of the satellites' North-South orbital planes have shifted approximately 31.6 degrees from the previous orbit.

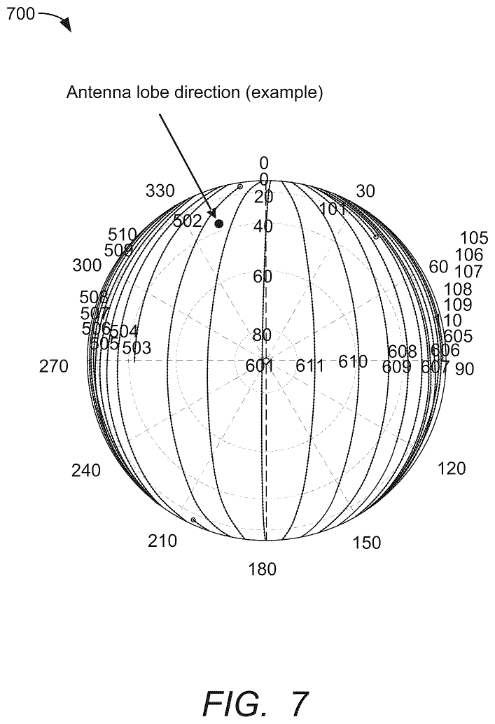

The present disclosure provides techniques for aligning a device's main antenna lobe with the LOS direction to a satellite when the user is not capable of following an interactive pointing procedure. The present disclosure assumes that a user not able to follow interactive UI prompts can often afford to wait (at least a couple of hours) before help arrives. Accordingly, when the user indicates that they are not capable of following an interactive pointing procedure, the device prompts the user to place the device on a stable surface (e.g., the ground) with few obstructions around in such a way that the main antenna lobe will be pointing towards some fixed direction in the sky, as shown in FIG. 7.

Note that the radiation pattern of most antennas is a pattern of “lobes” at various angles, i.e., directions where the radiated signal strength reaches a maximum, separated by “nulls,” i.e., angles at which the radiation falls to zero. In a directional/beamforming antenna, where the objective is to emit radio waves in a particular direction, the lobe in that direction is designed to have higher field strength than the other lobes and is referred to as the “main lobe” (or “main antenna lobe” or the like). The other lobes are referred to as “sidelobes” and usually represent unwanted radiation in undesired directions. The main lobe of a handheld smartphone typically radiates out the back of the device, but may in some cases radiate out the front of the device or in some other direction. As such, the device may prompt the user to place the device face down on the ground (or face up or tilted, depending on the antenna design/placement) so that the main antenna lobe will be pointing towards the sky.

FIG. 7 illustrates an example sky plot 700 of the trajectories of Iridium NEXT satellites as viewed by a device in San Diego, California, according to aspects of the disclosure. In the example of FIG. 7, the user has placed the device face down and the main antenna lobe is pointing in a direction having an azimuth angle of approximately 340 degrees and an elevation angle of approximately 40 degrees. Note that in some cases, the main lobe may be significantly asymmetrical, such as squished in one dimension. Then, for example, the antenna will be pointing to an arc in the sky plot rather than a dot. Such information should be taken into account when identifying alignment opportunities.

The device predicts the trajectories of any satellites to which it can transmit an emergency message to determine when in the near future the main antenna lobe of at least one antenna and at least one such satellite will be sufficiently aligned that the device can transmit the emergency message within its link budget and power consumption capabilities (e.g., amplifier capabilities, antenna configuration, remaining battery, etc.) with a reasonable chance of success. For Iridium NEXT satellites, for example, the maximum time to obtain a sufficiently close alignment is about two hours. The typical (median) time should therefore be close to one hour. In the example of FIG. 7, satellite 502 may be a good candidate.

At the predicted time, the main antenna lobe is assumed to be aligned with the LOS direction to the satellite (as determined from the satellite's known or estimated trajectory and the device's current location). The device therefore transmits the emergency message at that time. The device may retry the transmission as necessary (e.g., if no acknowledgment, for increased robustness, etc.). The device may provide some indication to the user that the message was sent, such as a chime, a voice notification, and/or the like.

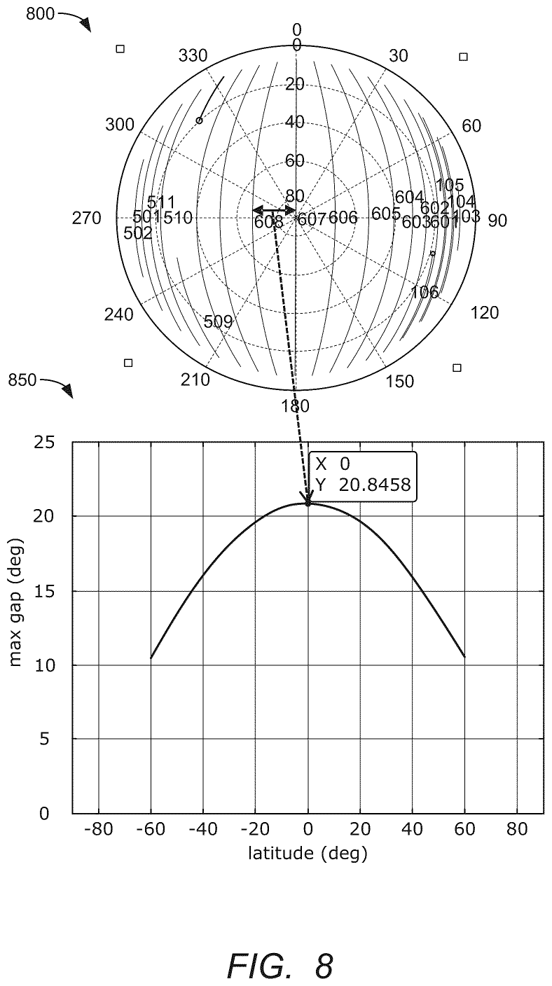

The accuracy of the main antenna lobe alignment with a satellite may depend on the location of the device. FIG. 8 illustrates an example of the maximum alignment error for Iridium NEXT satellites as viewed from an observation point on the Equator, according to aspects of the disclosure. For Iridium NEXT satellites, the maximum gap between trajectories (denoted by the horizontal double arrow on the sky plot 800) is 20.8 degrees for a user at the Equator, which suggests that a maximum alignment error of +/−10.4 degrees is achievable in 2.1 hours. This maximum gap reduces as latitude increases (roughly as cos(latitude)), as shown in the graph 850. Overall, this provides a +/−5 to 10 degree error, depending on the latitude. This error can be well tolerated by the width of the antenna lobe (e.g., in one implementation, a 1 dB lobe width is approximately 20 degrees).

Angular alignment error is largest near the zenith, where the link budget is also the easiest to meet. As such, there is a natural mitigating effect. Practically, a 4 to 5 dB advantage has been observed for satellites in the top of the sky, despite satellite beam powers having been adjusted based on the coverage directions they serve. For context, in interactive pointing scenarios, the user's hand will not be perfectly steady, so there is a systemic pointing error in that scheme as well.

Note that an “alignment” may not be an absolute alignment, but rather, a “soft,” or potential, alignment that occurs when the device estimates that a satellite is located somewhere within, or at least at the edge of, the estimated width of the main antenna lobe. This “potential” alignment is due to the existence of noise and uncertainties in the available information and recognizes that even a non-ideal alignment can still support successful communication. Thus, as used herein, an alignment is a potential alignment, since there is no guarantee, for at least the foregoing reasons, that the alignment between an antenna main lobe and a satellite will be an absolute alignment, or even sufficient for successful communication. A potential alignment opportunity is a period of time (or window) during which the main antenna lobe of at least one antenna is expected to be aligned with at least one satellite. A specific implementation can balance the time to communicate with the wakeup duty cycle (power consumption) in determining a potential alignment opportunity.

As will be appreciated, the more satellites that will be visible, the lower will be the alignment error and wait time. In addition, any alignment error is further reduced over longer time scales. Further, antenna steering/switching/beamforming can help to further reduce alignment error and/or wait time.

In an aspect, the above-described procedure can be a supplement to an interactive user pointing process. For example, the user may be given both options, or the device may prompt the user to indicate whether they are able to follow pointing instructions. If the device determines that the user was not able to follow the pointing procedure (e.g., based on one or more failed attempts), the device may offer or automatically trigger the above-described procedure.

In the case that the device is located on a moving platform, such as a ship at sea, or where the device is placed on a surface that is suspended and/or flexes, the device may not be “stable” after being put down. In these cases, the device can remind the user to not touch the device. Once confirmed that user is not touching the device (via, e.g., prompt or on-board sensor(s)), the device can evaluate the platform's movement pattern. If the movement is too violent and unpredictable, the device may have to abort the procedure and can notify user. Otherwise, the movement will cause the antenna lobe direction to jitter and shift/oscillate (slowly) over time. The disclosed procedure can still be performed, but the device should allow for a larger margin of error. For example, the device may attempt more near-alignment opportunities. In addition, some prediction might also be helpful.

In an aspect, the device may notify the user when the next communication attempt will be. This may be after the device has been placed on the ground, has estimated the satellite trajectories, and determined when the main antenna lobe should be aligned with a satellite.

In an aspect, the device may prompt the user to reposition the device after the user has placed it on the ground. This may be beneficial where the antenna lobe points to a negative or close-to-0 elevation angle. Alternatively or additionally, this may be beneficial where the expected wait time is long and repositioning may reduce that wait time.

In an aspect, the evaluation for alignment can be additionally based on the received signal strength from one or more satellites. For example, multiple near-alignment communication opportunities can be tried. Specifically, the device can wake up when a satellite gets closer to alignment and actively monitor the received signal strength from that satellite. If the received signal strength is sufficiently high (e.g., above some threshold), the device may consider the satellite sufficiently aligned to transmit the emergency message.

Note that regarding power consumption, once the device has determined the future time(s) for alignment, the device (or just the emergency feature) can go to sleep and only wake up to transmit at the predicted time(s). During this sleep mode the device should not be moved. A very low power sensor can be used to detect any motion and trigger a wakeup in the event that motion is detected.

Although the foregoing has generally described the emergency message via satellite scenario, as will be appreciated, the techniques are also applicable to IoT over NTN scenarios. With respect to latency, IoT use cases are often less sensitive to communication delays, which fits well with the proposed techniques. Regarding power savings, the present techniques save transmission power via improved link budget at the time of transmission. There are also power savings on search and measurement by estimating when to turn on the transmitter/receiver (and sleeping at other times).

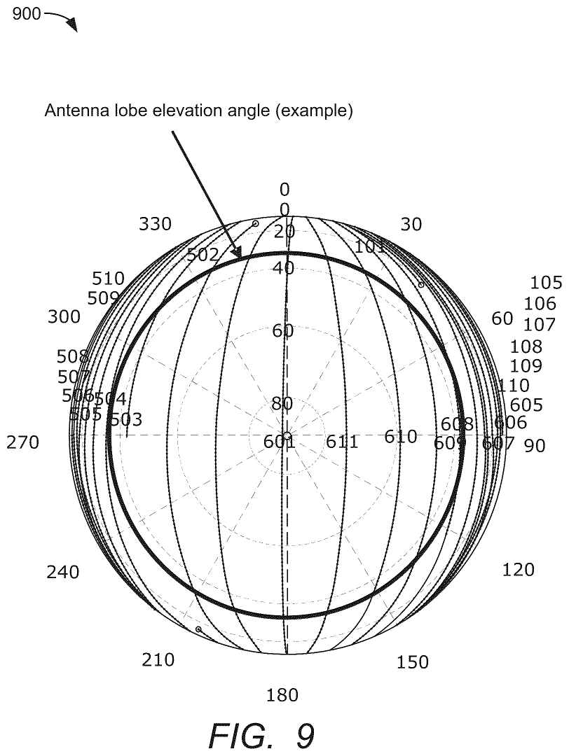

Regarding the sensors that might be used, inertial measurement units (IMUs), especially accelerometers, are commonly available in mobile and IoT wireless devices. If the device is equipped with an IMU and magnetometer, the device will be able to estimate its full orientation with respect to the Earth. Methods and application programming interfaces (APIs) exist for estimating such orientation, for example, by using the Rotation Vector sensor or Geomagnetic Rotation Vector sensors defined in Android. If the device is equipped with an IMU only or even an accelerometer only, the device's antenna elevation angle from the horizontal plane can be estimated based on an estimated direction of gravity, as shown in FIG. 9. In this case, the device can still duty cycle its communication attempts based on predictions of available satellite elevation angles.

FIG. 9 illustrates an example sky plot 900 of the trajectories of Iridium NEXT satellites as viewed by a device in San Diego, California, according to aspects of the disclosure. In the example of FIG. 9, the device is only able to determine the elevation angle of its main antenna lobe, illustrated as a heavy circle at approximately 30 degrees of elevation. Specifically, gravity is one vector in the device body frame and the main lobe is another vector in the device body frame. The horizontal plane can be determined from the gravity vector, and then based on the main lobe vector, the elevation angle of the main lobe can be determined. The device can select communication attempts based on when a satellite is predicted to align with the main antenna lobe's elevation angle.

With continued reference to the IoT use case, in some scenarios, the IoT device may be on a moving platform. In this case, the techniques of the present disclosure can still be applied if the platform is relatively stable and traveling in a straight line or on a level surface (e.g., a ship at sea or a train). In such a scenario, an elevation-angle-based scheme (as described above with reference to FIG. 9) can be used. The full solution can be applied if the platform is traveling in a straight line. Note that a typical ship moves slowly enough that its location change on the surface of the Earth over a couple of hours is negligibly small (e.g., tens of kilometers) relative to its distance to the satellites (approximately 1000 kilometers or more).

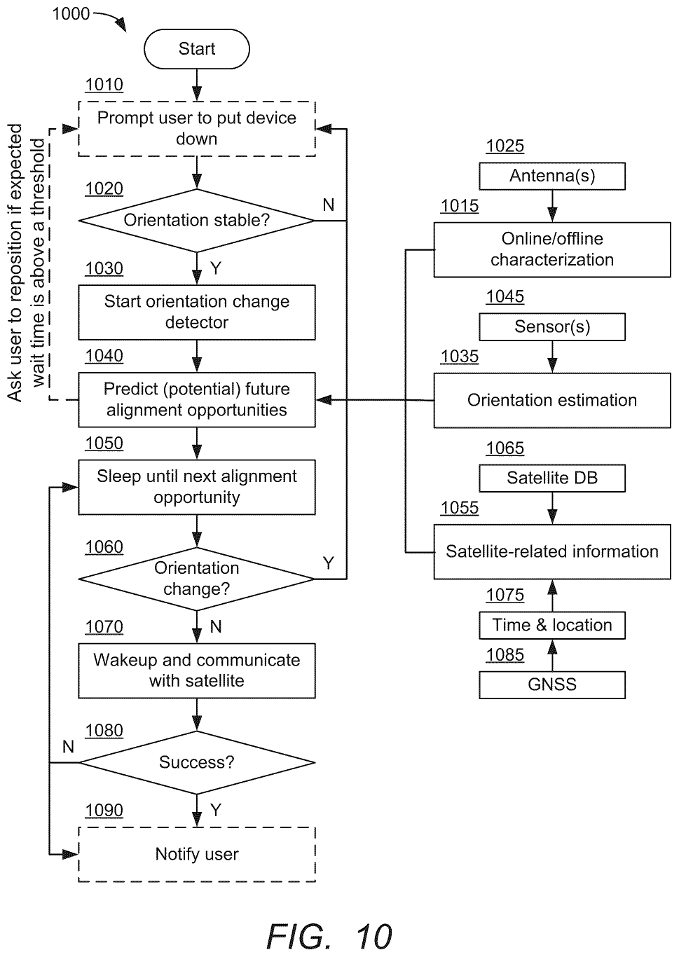

FIG. 10 is an example method 1000 of aligning a device's main antenna lobe with the LOS direction to a satellite, according to aspects of the disclosure. The method 1000 may be performed by any of the UEs described herein, such as UE 302, and generically referred to as a “device.” The method 1000 may be triggered in response to different events. For example, the method 1000 may be triggered when the device has no cellular connectivity and user attempts to make an emergency call. Alternatively, even if there is cellular connectivity, the user may trigger such an SOS via satellite emergency call. As another example, the method 1000 may be triggered automatically, for example, by a V-UE when it detects that the airbags have deployed, an engine failure, a fire detected, etc. For an IoT scenario, the method 1000 may be triggered based on the device detecting a critical situation, such as a water or gas leak. Note that the method 1000 does not have to be triggered by an emergency situation; rather, the device may be configured to report information, such as tracking data.

At operation 1010, the device optionally prompts the user to put the device down (e.g., face down on a stable surface with few obstructions around). Operation 1010 is optional because it would not be performed where the method 1000 does not involve user interaction, such as the IoT use case.

At operation 1020, the device determines whether the orientation of the device is stable (i.e., not changing, or at least no more than a small threshold). The “orientation” may be a three-degrees-of-freedom (3DOF) orientation relative to the Earth's frame (e.g., the Rotation Vector in Android), a one-degree-of-freedom (1DOF) orientation (e.g., tilt angle only, or azimuth only), or other variants of orientation-related information. The sensors used to determine the 3DOF, 1DOF, etc. may include one or more accelerometers, a gyroscope, a magnetometer, and/or others. If the orientation is stable, the method 1000 proceeds to operation 1030. If the orientation is not stable, the method 1000 returns to operation 1010 (if applicable), or waits until the orientation is either stable or predictable (e.g., as in an IoT scenario).

At operation 1030, the device starts an orientation change detector. Orientation change detection can be implemented directly (e.g., via the same sensors that determined whether the orientation of the device is stable), or via (low power) alternatives, like some type of motion detector (e.g., an accelerometer).

At operation 1040, the device predicts (potential) future alignment opportunities. As shown in FIG. 10, there are various inputs to this determination. A first input includes possible antenna patterns (e.g., the orientation/direction and shape/beamwidth of the transmit and/or receive beams the antenna(s) 1025 are capable of generating), which are determined based on online and/or offline characterization(s) 1015 of the device's antenna(s) 1025. Note that some devices may have multiple antennas or an antenna array, and the pattern (e.g., orientation/direction and shape/beamwidth) of the main lobe of one antenna may be different than the pattern of the main lobe of a different antenna. As such, these different antenna patterns may allow for different alignment opportunities with the same satellite at different times, with different satellites at the same time, or the like.

A second input includes the device's orientation (and optionally the corresponding orientation uncertainty) as determined based on an orientation estimation 1035. The orientation estimation 1035 may be based on inputs from one or more sensors 1045 (e.g., one or more accelerometers, a gyroscope, a magnetometer, and/or other orientation sensors). A third input includes estimates of satellite trajectories, signal strength measurements of any detectable satellites, and/or any satellite preferences of the user or device (e.g., NTN, network operator, subscription information, etc.). These estimates may be based on satellite-related information 1055. The satellite-related information 1055 may be based on a satellite database (DB) 1065 of known satellite trajectories (e.g., an ephemeris database for Iridium NEXT satellites) and the current time and location 1075 of the device. The satellite DB 1065 may have been preconfigured on the device or downloaded to the device when it has cellular or other connectivity. The current time and location 1075 of the device may be determined based on a global navigation satellite system (GNSS) 1085, such as GPS.

In an aspect, if the expected wait time to an alignment opportunity is greater than some threshold, the device may optionally return to operation 1010 and prompt the user to reposition the device. The device may indicate how the user should reposition the device (e.g., place on a tilt instead of flat on its face).

At operation 1050, the device goes to sleep (i.e., enters a sleep mode) until the next alignment opportunity. While this operation is not strictly necessary, it is beneficial to conserve power consumption. The device should at least refrain from transmitting any emergency (SOS) messages until the next alignment opportunity.

At operation 1060, once “asleep,” the device monitors for any change in orientation until the device is scheduled to wakeup and transmit the emergency message. If any change in orientation is detected, the method 1000 returns to operation 1010 (if applicable) or operation 1020 (if operation 1010 is not applicable).

At operation 1070, the device wakes up and transmits the emergency message. The device may receive an acknowledgment form the satellite that the message was received, a negative acknowledgment indicating that the message was not properly received, or no acknowledgment.

At operation 1080, the device determines whether the message was transmitted successfully. If it was (e.g., the device received an acknowledgment from the satellite), then the method 1000 proceeds to operation 1090. If it was not, the method 1000 returns to operation 1050 and goes back to sleep until the next alignment opportunity. The method 1000 may also proceed to operation 1090 in this case.

At operation 1090, the device optionally notifies the user that the emergency was (or was not) transmitted successfully. The method 1000 then ends.

Note that while the foregoing has generally described a wireless communication device transmitting messages to a satellite (i.e., uplink transmissions), as will be appreciated, the techniques described above are equally applicable to the wireless communication device receiving transmissions from the satellite (i.e., downlink transmissions). For example, the device may determine alignment opportunities during which it will wake up to attempt to receive messages (e.g., paging messages, weather alerts, etc.) from a satellite.

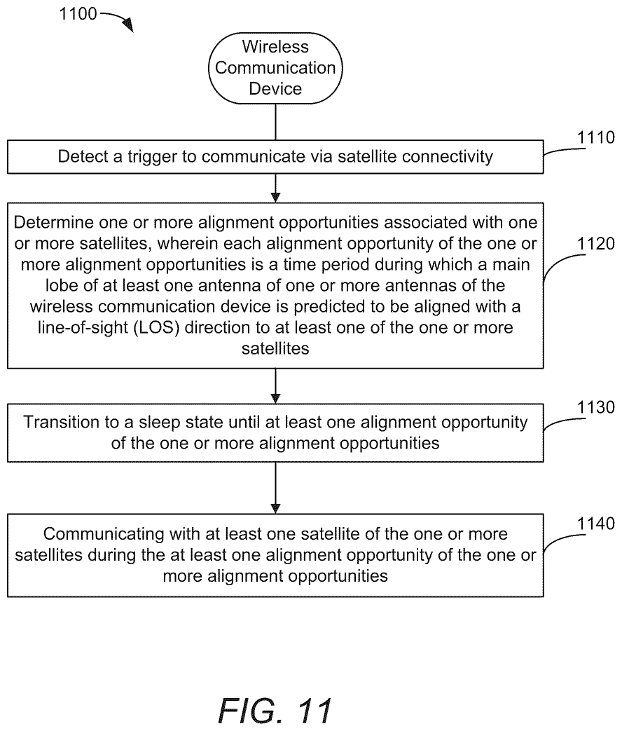

FIG. 11 illustrates an example method 1100 of wireless communication, according to aspects of the disclosure. In an aspect, method 1100 may be performed by a wireless communication device (e.g., any of the UEs described herein).

At 1110, the wireless communication device detects a trigger to communicate via satellite connectivity. In an aspect, operation 1110 may be performed by the one or more WWAN transceivers 310, the satellite interface 330, the one or more processors 342, memory 340, and/or alignment component 348, any or all of which may be considered means for performing this operation.

At 1120, the wireless device determines one or more alignment opportunities associated with one or more satellites, as at operation 1040, wherein each alignment opportunity of the one or more alignment opportunities is a time period during which a main lobe of at least one antenna of one or more antennas of the wireless communication device is predicted to be aligned with a line-of-sight (LOS) direction to at least one satellite of the one or more satellites. In an aspect, operation 1120 may be performed by the one or more WWAN transceivers 310, the satellite interface 330, the one or more processors 342, memory 340, and/or alignment component 348, any or all of which may be considered means for performing this operation.

At 1130, the wireless communication device transitions to a sleep state until at least one alignment opportunity of the one or more alignment opportunities, as at operation 1050. In an aspect, operation 1130 may be performed by the one or more WWAN transceivers 310, the satellite interface 330, the one or more processors 342, memory 340, and/or alignment component 348, any or all of which may be considered means for performing this operation.

At 1140, the wireless communication device communicates with at least one satellite of the one or more satellites during the at least one alignment opportunity of the one or more alignment opportunities, as at operation 1070. In an aspect, operation 1140 may be performed by the one or more WWAN transceivers 310, the satellite interface 330, the one or more processors 342, memory 340, and/or alignment component 348, any or all of which may be considered means for performing this operation.

As will be appreciated, a technical advantage of the method 1100 is reduced power consumption, reduced BOM, and increased likelihood of successfully communicating with the satellite, especially when the wireless communication device cannot be moved, or the user is not able to follow an interactive pointing procedure.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a wireless communication device, comprising: detecting a trigger to communicate via satellite connectivity; determining one or more alignment opportunities associated with one or more satellites, wherein each alignment opportunity of the one or more alignment opportunities is a time period during which a main lobe of at least one antenna of one or more antennas of the wireless communication device is predicted to be aligned with a line-of-sight (LOS) direction to at least one of the one or more satellites; refraining from communicating with the one or more satellites until at least one alignment opportunity of the one or more alignment opportunities; and communicating with at least one satellite of the one or more satellites during the at least one alignment opportunity of the one or more alignment opportunities.

Clause 2. The method of clause 1, wherein the one or more alignment opportunities are determined based on: a characterization of an orientation and shape of each main lobe of each of the one or more antennas relative to the wireless communication device, an estimate of an orientation of the wireless communication device relative to the Earth, an estimate of an uncertainty of the orientation of the wireless communication device, an estimate of trajectories of the one or more satellites, signal strength measurements of the one or more satellites, one or more preferences related to selecting the one or more satellites, or any combination thereof.

Clause 3. The method of clause 2, wherein the orientation of the wireless communication device relative to the Earth comprises a gravity direction only.

Clause 4. The method of any of clauses 1 to 3, further comprising: determining whether an orientation of the wireless communication device is stable.

Clause 5. The method of clause 4, further comprising: initiating an orientation change detector based on the orientation of the wireless communication device being stable; or prompting a user of the wireless communication device to place the wireless communication device on a stable surface based on the orientation of the wireless communication device not being stable.

Clause 6. The method of clause 5, wherein the wireless communication device communicates with the at least one satellite during the at least one alignment opportunity of the one or more alignment opportunities based on the orientation change detector not detecting a change in the orientation of the wireless communication device.

Clause 7. The method of any of clauses 1 to 6, further comprising: determining that the one or more alignment opportunities will not occur within a threshold period of time of a current time; and prompting a user of the wireless communication device to reposition the wireless communication device.

Clause 8. The method of any of clauses 1 to 7, wherein refraining from communicating with the one or more satellites comprises: transitioning to a sleep state until the at least one alignment opportunity of the one or more alignment opportunities.

Clause 9. The method of any of clauses 1 to 8, wherein determining the one or more alignment opportunities comprises: determining one or more first alignment opportunities associated with the one or more satellites; detecting movement of the wireless communication device before the one or more first alignment opportunities; and determining one or more second alignment opportunities associated with the one or more satellites based on the movement of the wireless communication device.

Clause 10. The method of any of clauses 1 to 9, further comprising: determining whether or not communication with the at least one satellite was successful.

Clause 11. The method of clause 10, wherein: communicating with the at least one satellite comprises transmitting a message to the at least one satellite, and the message is determined to have been transmitted successfully based on reception of an acknowledgment from the at least one satellite.

Clause 12. The method of any of clauses 10 to 11, further comprising: notifying a user of the wireless communication device whether or not communication with the at least one satellite was successful.

Clause 13. The method of any of clauses 10 to 12, further comprising: re-attempting to communicate with the at least one satellite based on communication with the at least one satellite being unsuccessful.

Clause 14. The method of any of clauses 1 to 13, further comprising: prompting a user of the wireless communication device to place the wireless communication device on a stable surface such that a main lobe of at least one of the one or more antennas faces upward.

Clause 15. The method of any of clauses 1 to 14, further comprising: determining that the wireless communication device is not stationary; determining a pattern of movement of the wireless communication device; and increasing a margin of error of the one or more alignment opportunities based on the pattern of movement.

Clause 16. The method of any of clauses 1 to 15, further comprising: notifying a user of the wireless communication device of a time of a next alignment opportunity of the one or more alignment opportunities.

Clause 17. The method of any of clauses 1 to 16, further comprising: monitoring a signal strength of the at least one satellite before communication with the at least one satellite, wherein communication with the at least one satellite is based on the signal strength of the at least one satellite being above a threshold.

Clause 18. The method of any of clauses 1 to 17, wherein detecting the trigger comprises: receiving a request from a user of the wireless communication device to communicate via satellite connectivity; detecting an emergency event at the wireless communication device; determining that the user is incapable of performing an interactive pointing procedure with the wireless communication device; or any combination thereof.

Clause 19. The method of clause 18, further comprising: displaying a prompt to the user to choose to perform the interactive pointing procedure or the method of wireless communication, wherein the user is determined to be incapable of performing the interactive pointing procedure based on reception of user input to perform the method of wireless communication.

Clause 20. The method of any of clauses 18 to 19, further comprising: detecting a plurality of failed attempts to perform the interactive pointing procedure, wherein the user is determined to be incapable of performing the interactive pointing procedure based on the plurality of failed attempts being detected.

Clause 21. The method of any of clauses 1 to 20, wherein: communicating with the at least one satellite comprises transmitting at least one first message to the at least one satellite, communicating with the at least one satellite comprises receiving at least one second message from the at least one satellite, or any combination thereof.

Clause 22. The method of any of clauses 1 to 21, wherein the wireless communication device is: an Internet of Things (IoT) device, or a wireless communications device.

Clause 23. The method of any of clauses 1 to 22, wherein the trigger to communicate via satellite connectivity is based on the wireless communication device not having cellular connectivity.

Clause 24. A wireless communication device, comprising: one or more memories; one or more transceivers; and one or more processors communicatively coupled to the one or more memories and the one or more transceivers, the one or more processors, either alone or in combination, configured to: detect a trigger to communicate via satellite connectivity; determine one or more alignment opportunities associated with one or more satellites, wherein each alignment opportunity of the one or more alignment opportunities is a time period during which a main lobe of at least one antenna of one or more antennas of the wireless communication device is predicted to be aligned with a line-of-sight (LOS) direction to at least one of the one or more satellites; refrain from communicating with the one or more satellites until at least one alignment opportunity of the one or more alignment opportunities; and communicate, via the one or more transceivers, with at least one satellite of the one or more satellites during the at least one alignment opportunity of the one or more alignment opportunities.

Clause 25. The wireless communication device of clause 24, wherein the one or more alignment opportunities are determined based on: a characterization of an orientation and shape of each main lobe of each of the one or more antennas relative to the wireless communication device, an estimate of an orientation of the wireless communication device relative to the Earth, an estimate of an uncertainty of the orientation of the wireless communication device, an estimate of trajectories of the one or more satellites, signal strength measurements of the one or more satellites, one or more preferences related to selecting the one or more satellites, or any combination thereof.

Clause 26. The wireless communication device of clause 25, wherein the orientation of the wireless communication device relative to the Earth comprises a gravity direction only.

Clause 27. The wireless communication device of any of clauses 24 to 26, wherein the one or more processors, either alone or in combination, are further configured to: determine whether an orientation of the wireless communication device is stable.

Clause 28. The wireless communication device of clause 27, wherein the one or more processors, either alone or in combination, are further configured to: initiate an orientation change detector based on the orientation of the wireless communication device being stable; or prompt a user of the wireless communication device to place the wireless communication device on a stable surface based on the orientation of the wireless communication device not being stable.

Clause 29. The wireless communication device of clause 28, wherein the wireless communication device communicates with the at least one satellite during the at least one alignment opportunity of the one or more alignment opportunities based on the orientation change detector not detecting a change in the orientation of the wireless communication device.

Clause 30. The wireless communication device of any of clauses 24 to 29, wherein the one or more processors, either alone or in combination, are further configured to: determine that the one or more alignment opportunities will not occur within a threshold period of time of a current time; and prompt a user of the wireless communication device to reposition the wireless communication device.

Clause 31. The wireless communication device of any of clauses 24 to 30, wherein the one or more processors configured to refrain from communicating with the one or more satellites comprises the one or more processors, either alone or in combination, configured to: transition to a sleep state until the at least one alignment opportunity of the one or more alignment opportunities.

Clause 32. The wireless communication device of any of clauses 24 to 31, wherein the one or more processors configured to determine the one or more alignment opportunities comprises the one or more processors, either alone or in combination, configured to: determine one or more first alignment opportunities associated with the one or more satellites; detect movement of the wireless communication device before the one or more first alignment opportunities; and determine one or more second alignment opportunities associated with the one or more satellites based on the movement of the wireless communication device.

Clause 33. The wireless communication device of any of clauses 24 to 32, wherein the one or more processors, either alone or in combination, are further configured to: determine whether or not communication with the at least one satellite was successful.

Clause 34. The wireless communication device of clause 33, wherein: communicating with the at least one satellite comprises transmitting a message to the at least one satellite, and the message is determined to have been transmitted successfully based on reception of an acknowledgment from the at least one satellite.

Clause 35. The wireless communication device of any of clauses 33 to 34, wherein the one or more processors, either alone or in combination, are further configured to: notify a user of the wireless communication device whether or not communication with the at least one satellite was successful.

Clause 36. The wireless communication device of any of clauses 33 to 35, wherein the one or more processors, either alone or in combination, are further configured to: re-attempt to communicate with the at least one satellite based on communication with the at least one satellite being unsuccessful.

Clause 37. The wireless communication device of any of clauses 24 to 36, wherein the one or more processors, either alone or in combination, are further configured to: prompt a user of the wireless communication device to place the wireless communication device on a stable surface such that a main lobe of at least one of the one or more antennas faces upward.

Clause 38. The wireless communication device of any of clauses 24 to 37, wherein the one or more processors, either alone or in combination, are further configured to: determine that the wireless communication device is not stationary; determine a pattern of movement of the wireless communication device; and increase a margin of error of the one or more alignment opportunities based on the pattern of movement.

Clause 39. The wireless communication device of any of clauses 24 to 38, wherein the one or more processors, either alone or in combination, are further configured to: notify a user of the wireless communication device of a time of a next alignment opportunity of the one or more alignment opportunities.

Clause 40. The wireless communication device of any of clauses 24 to 39, wherein the one or more processors, either alone or in combination, are further configured to: monitor a signal strength of the at least one satellite before communication with the at least one satellite, wherein communication with the at least one satellite is based on the signal strength of the at least one satellite being above a threshold.

Clause 41. The wireless communication device of any of clauses 24 to 40, wherein the one or more processors configured to detect the trigger comprises the one or more processors, either alone or in combination, configured to: receive, via the one or more transceivers, a request from a user of the wireless communication device to communicate via satellite connectivity; detect an emergency event at the wireless communication device; determine that the user is incapable of performing an interactive pointing procedure with the wireless communication device; or any combination thereof.

Clause 42. The wireless communication device of clause 41, wherein the one or more processors, either alone or in combination, are further configured to: display a prompt to the user to choose to perform the interactive pointing procedure or the method of wireless communication, wherein the user is determined to be incapable of performing the interactive pointing procedure based on reception of user input to perform the method of wireless communication.

Clause 43. The wireless communication device of any of clauses 41 to 42, wherein the one or more processors, either alone or in combination, are further configured to: detect a plurality of failed attempts to perform the interactive pointing procedure, wherein the user is determined to be incapable of performing the interactive pointing procedure based on the plurality of failed attempts being detected.

Clause 44. The wireless communication device of any of clauses 24 to 43, wherein: communicate, via the one or more transceivers, with the at least one satellite comprises transmitting at least one first message to the at least one satellite, communicate, via the one or more transceivers, with the at least one satellite comprises receiving at least one second message from the at least one satellite, or any combination thereof.

Clause 45. The wireless communication device of any of clauses 24 to 44, wherein the wireless communication device is: an Internet of Things (IoT) device, or a wireless communications device.

Clause 46. The wireless communication device of any of clauses 24 to 45, wherein the trigger to communicate via satellite connectivity is based on the wireless communication device not having cellular connectivity.

Clause 47. A wireless communication device, comprising: means for detecting a trigger to communicate via satellite connectivity; means for determining one or more alignment opportunities associated with one or more satellites, wherein each alignment opportunity of the one or more alignment opportunities is a time period during which a main lobe of at least one antenna of one or more antennas of the wireless communication device is predicted to be aligned with a line-of-sight (LOS) direction to at least one of the one or more satellites; means for refraining from communicating with the one or more satellites until at least one alignment opportunity of the one or more alignment opportunities; and means for communicating with at least one satellite of the one or more satellites during the at least one alignment opportunity of the one or more alignment opportunities.

Clause 48. The wireless communication device of clause 47, wherein the one or more alignment opportunities are determined based on: a characterization of an orientation and shape of each main lobe of each of the one or more antennas relative to the wireless communication device, an estimate of an orientation of the wireless communication device relative to the Earth, an estimate of an uncertainty of the orientation of the wireless communication device, an estimate of trajectories of the one or more satellites, signal strength measurements of the one or more satellites, one or more preferences related to selecting the one or more satellites, or any combination thereof.

Clause 49. The wireless communication device of clause 48, wherein the orientation of the wireless communication device relative to the Earth comprises a gravity direction only.

Clause 50. The wireless communication device of any of clauses 47 to 49, further comprising: means for determining whether an orientation of the wireless communication device is stable.

Clause 51. The wireless communication device of clause 50, further comprising: means for initiating an orientation change detector based on the orientation of the wireless communication device being stable; or means for prompting a user of the wireless communication device to place the wireless communication device on a stable surface based on the orientation of the wireless communication device not being stable.

Clause 52. The wireless communication device of clause 51, wherein the wireless communication device communicates with the at least one satellite during the at least one alignment opportunity of the one or more alignment opportunities based on the orientation change detector not detecting a change in the orientation of the wireless communication device.

Clause 53. The wireless communication device of any of clauses 47 to 52, further comprising: means for determining that the one or more alignment opportunities will not occur within a threshold period of time of a current time; and means for prompting a user of the wireless communication device to reposition the wireless communication device.

Clause 54. The wireless communication device of any of clauses 47 to 53, wherein the means for refraining from communicating with the one or more satellites comprises: means for transitioning to a sleep state until the at least one alignment opportunity of the one or more alignment opportunities.

Clause 55. The wireless communication device of any of clauses 47 to 54, wherein the means for determining the one or more alignment opportunities comprises: means for determining one or more first alignment opportunities associated with the one or more satellites; means for detecting movement of the wireless communication device before the one or more first alignment opportunities; and means for determining one or more second alignment opportunities associated with the one or more satellites based on the movement of the wireless communication device.

Clause 56. The wireless communication device of any of clauses 47 to 55, further comprising: means for determining whether or not communication with the at least one satellite was successful.

Clause 57. The wireless communication device of clause 56, wherein: communicating with the at least one satellite comprises transmitting a message to the at least one satellite, and the message is determined to have been transmitted successfully based on reception of an acknowledgment from the at least one satellite.

Clause 58. The wireless communication device of any of clauses 56 to 57, further comprising: means for notifying a user of the wireless communication device whether or not communication with the at least one satellite was successful.

Clause 59. The wireless communication device of any of clauses 56 to 58, further comprising: means for re-attempting to communicate with the at least one satellite based on communication with the at least one satellite being unsuccessful.

Clause 60. The wireless communication device of any of clauses 47 to 59, further comprising: means for prompting a user of the wireless communication device to place the wireless communication device on a stable surface such that a main lobe of at least one of the one or more antennas faces upward.

Clause 61. The wireless communication device of any of clauses 47 to 60, further comprising: means for determining that the wireless communication device is not stationary; means for determining a pattern of movement of the wireless communication device; and means for increasing a margin of error of the one or more alignment opportunities based on the pattern of movement.

Clause 62. The wireless communication device of any of clauses 47 to 61, further comprising: means for notifying a user of the wireless communication device of a time of a next alignment opportunity of the one or more alignment opportunities.

Clause 63. The wireless communication device of any of clauses 47 to 62, further comprising: means for monitoring a signal strength of the at least one satellite before communication with the at least one satellite, wherein communication with the at least one satellite is based on the signal strength of the at least one satellite being above a threshold.

Clause 64. The wireless communication device of any of clauses 47 to 63, wherein the means for detecting the trigger comprises: means for receiving a request from a user of the wireless communication device to communicate via satellite connectivity; means for detecting an emergency event at the wireless communication device; means for determining that the user is incapable of performing an interactive pointing procedure with the wireless communication device; or any combination thereof.

Clause 65. The wireless communication device of clause 64, further comprising: means for displaying a prompt to the user to choose to perform the interactive pointing procedure or the method of wireless communication, wherein the user is determined to be incapable of performing the interactive pointing procedure based on reception of user input to perform the method of wireless communication.

Clause 66. The wireless communication device of any of clauses 64 to 65, further comprising: means for detecting a plurality of failed attempts to perform the interactive pointing procedure, wherein the user is determined to be incapable of performing the interactive pointing procedure based on the plurality of failed attempts being detected.

Clause 67. The wireless communication device of any of clauses 47 to 66, wherein: means for communicating with the at least one satellite comprises transmitting at least one first message to the at least one satellite, means for communicating with the at least one satellite comprises receiving at least one second message from the at least one satellite, or any combination thereof.

Clause 68. The wireless communication device of any of clauses 47 to 67, wherein the wireless communication device is: an Internet of Things (IoT) device, or a wireless communications device.

Clause 69. The wireless communication device of any of clauses 47 to 68, wherein the trigger to communicate via satellite connectivity is based on the wireless communication device not having cellular connectivity.

Clause 70. A non-transitory computer-readable medium storing computer-executable instructions that, when executed by a wireless communication device, cause the wireless communication device to: detect a trigger to communicate via satellite connectivity; determine one or more alignment opportunities associated with one or more satellites, wherein each alignment opportunity of the one or more alignment opportunities is a time period during which a main lobe of at least one antenna of one or more antennas of the wireless communication device is predicted to be aligned with a line-of-sight (LOS) direction to at least one of the one or more satellites; refrain from communicating with the one or more satellites until at least one alignment opportunity of the one or more alignment opportunities; and communicate with at least one satellite of the one or more satellites during the at least one alignment opportunity of the one or more alignment opportunities.

Clause 71. The non-transitory computer-readable medium of clause 70, wherein the one or more alignment opportunities are determined based on: a characterization of an orientation and shape of each main lobe of each of the one or more antennas relative to the wireless communication device, an estimate of an orientation of the wireless communication device relative to the Earth, an estimate of an uncertainty of the orientation of the wireless communication device, an estimate of trajectories of the one or more satellites, signal strength measurements of the one or more satellites, one or more preferences related to selecting the one or more satellites, or any combination thereof.

Clause 72. The non-transitory computer-readable medium of clause 71, wherein the orientation of the wireless communication device relative to the Earth comprises a gravity direction only.

Clause 73. The non-transitory computer-readable medium of any of clauses 70 to 72, further comprising computer-executable instructions that, when executed by the wireless communication device, cause the wireless communication device to: determine whether an orientation of the wireless communication device is stable.

Clause 74. The non-transitory computer-readable medium of clause 73, further comprising computer-executable instructions that, when executed by the wireless communication device, cause the wireless communication device to: initiate an orientation change detector based on the orientation of the wireless communication device being stable; or prompt a user of the wireless communication device to place the wireless communication device on a stable surface based on the orientation of the wireless communication device not being stable.

Clause 75. The non-transitory computer-readable medium of clause 74, wherein the wireless communication device communicates with the at least one satellite during the at least one alignment opportunity of the one or more alignment opportunities based on the orientation change detector not detecting a change in the orientation of the wireless communication device.

Clause 76. The non-transitory computer-readable medium of any of clauses 70 to 75, further comprising computer-executable instructions that, when executed by the wireless communication device, cause the wireless communication device to: determine that the one or more alignment opportunities will not occur within a threshold period of time of a current time; and prompt a user of the wireless communication device to reposition the wireless communication device.

Clause 77. The non-transitory computer-readable medium of any of clauses 70 to 76, wherein the computer-executable instructions that, when executed by the wireless communication device, cause the wireless communication device to refrain from communicating with the one or more satellites comprise computer-executable instructions that, when executed by the wireless communication device, cause the wireless communication device to: transition to a sleep state until the at least one alignment opportunity of the one or more alignment opportunities.

Clause 78. The non-transitory computer-readable medium of any of clauses 70 to 77, wherein the computer-executable instructions that, when executed by the wireless communication device, cause the wireless communication device to determine the one or more alignment opportunities comprise computer-executable instructions that, when executed by the wireless communication device, cause the wireless communication device to: determine one or more first alignment opportunities associated with the one or more satellites; detect movement of the wireless communication device before the one or more first alignment opportunities; and determine one or more second alignment opportunities associated with the one or more satellites based on the movement of the wireless communication device.

Clause 79. The non-transitory computer-readable medium of any of clauses 70 to 78, further comprising computer-executable instructions that, when executed by the wireless communication device, cause the wireless communication device to: determine whether or not communication with the at least one satellite was successful.

Clause 80. The non-transitory computer-readable medium of clause 79, wherein: communicating with the at least one satellite comprises transmitting a message to the at least one satellite, and the message is determined to have been transmitted successfully based on reception of an acknowledgment from the at least one satellite.

Clause 81. The non-transitory computer-readable medium of any of clauses 79 to 80, further comprising computer-executable instructions that, when executed by the wireless communication device, cause the wireless communication device to: notify a user of the wireless communication device whether or not communication with the at least one satellite was successful.

Clause 82. The non-transitory computer-readable medium of any of clauses 79 to 81, further comprising computer-executable instructions that, when executed by the wireless communication device, cause the wireless communication device to: re-attempt to communicate with the at least one satellite based on communication with the at least one satellite being unsuccessful.

Clause 83. The non-transitory computer-readable medium of any of clauses 70 to 82, further comprising computer-executable instructions that, when executed by the wireless communication device, cause the wireless communication device to: prompt a user of the wireless communication device to place the wireless communication device on a stable surface such that a main lobe of at least one of the one or more antennas faces upward.

Clause 84. The non-transitory computer-readable medium of any of clauses 70 to 83, further comprising computer-executable instructions that, when executed by the wireless communication device, cause the wireless communication device to: determine that the wireless communication device is not stationary; determine a pattern of movement of the wireless communication device; and increase a margin of error of the one or more alignment opportunities based on the pattern of movement.

Clause 85. The non-transitory computer-readable medium of any of clauses 70 to 84, further comprising computer-executable instructions that, when executed by the wireless communication device, cause the wireless communication device to: notify a user of the wireless communication device of a time of a next alignment opportunity of the one or more alignment opportunities.

Clause 86. The non-transitory computer-readable medium of any of clauses 70 to 85, further comprising computer-executable instructions that, when executed by the wireless communication device, cause the wireless communication device to: monitor a signal strength of the at least one satellite before communication with the at least one satellite, wherein communication with the at least one satellite is based on the signal strength of the at least one satellite being above a threshold.

Clause 87. The non-transitory computer-readable medium of any of clauses 70 to 86, wherein the computer-executable instructions that, when executed by the wireless communication device, cause the wireless communication device to detect the trigger comprise computer-executable instructions that, when executed by the wireless communication device, cause the wireless communication device to: receive a request from a user of the wireless communication device to communicate via satellite connectivity; detect an emergency event at the wireless communication device; determine that the user is incapable of performing an interactive pointing procedure with the wireless communication device; or any combination thereof.

Clause 88. The non-transitory computer-readable medium of clause 87, further comprising computer-executable instructions that, when executed by the wireless communication device, cause the wireless communication device to: display a prompt to the user to choose to perform the interactive pointing procedure or the method of wireless communication, wherein the user is determined to be incapable of performing the interactive pointing procedure based on reception of user input to perform the method of wireless communication.

Clause 89. The non-transitory computer-readable medium of any of clauses 87 to 88, further comprising computer-executable instructions that, when executed by the wireless communication device, cause the wireless communication device to: detect a plurality of failed attempts to perform the interactive pointing procedure, wherein the user is determined to be incapable of performing the interactive pointing procedure based on the plurality of failed attempts being detected.

Clause 90. The non-transitory computer-readable medium of any of clauses 70 to 89, wherein: communicate with the at least one satellite comprises transmitting at least one first message to the at least one satellite, communicate with the at least one satellite comprises receiving at least one second message from the at least one satellite, or any combination thereof.

Clause 91. The non-transitory computer-readable medium of any of clauses 70 to 90, wherein the wireless communication device is: an Internet of Things (IoT) device, or a wireless communications device.

Clause 92. The non-transitory computer-readable medium of any of clauses 70 to 91, wherein the trigger to communicate via satellite connectivity is based on the wireless communication device not having cellular connectivity.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A method of wireless communication performed by a wireless communication device, comprising:
detecting a trigger to communicate via satellite connectivity;
determining one or more alignment opportunities associated with one or more satellites, wherein each alignment opportunity of the one or more alignment opportunities is a time period during which a main lobe of at least one antenna of one or more antennas of the wireless communication device is predicted to be aligned with a line-of-sight (LOS) direction to at least one of the one or more satellites;
refraining from communicating with the one or more satellites until at least one alignment opportunity of the one or more alignment opportunities; and
communicating with at least one satellite of the one or more satellites during the at least one alignment opportunity of the one or more alignment opportunities.

2. The method of claim 1, wherein the one or more alignment opportunities are determined based on:
a characterization of an orientation and shape of each main lobe of each of the one or more antennas relative to the wireless communication device,
an estimate of an orientation of the wireless communication device relative to the Earth,
an estimate of an uncertainty of the orientation of the wireless communication device,
an estimate of trajectories of the one or more satellites,
signal strength measurements of the one or more satellites,
one or more preferences related to selecting the one or more satellites, or
any combination thereof.

3. The method of claim 2, wherein the orientation of the wireless communication device relative to the Earth comprises a gravity direction only.

4. The method of claim 1, further comprising:
determining whether an orientation of the wireless communication device is stable.

5. The method of claim 4, further comprising:
initiating an orientation change detector based on the orientation of the wireless communication device being stable; or
prompting a user of the wireless communication device to place the wireless communication device on a stable surface based on the orientation of the wireless communication device not being stable.

6. The method of claim 5, wherein the wireless communication device communicates with the at least one satellite during the at least one alignment opportunity of the one or more alignment opportunities based on the orientation change detector not detecting a change in the orientation of the wireless communication device.

7. The method of claim 1, further comprising:
determining that the one or more alignment opportunities will not occur within a threshold period of time of a current time; and
prompting a user of the wireless communication device to reposition the wireless communication device.

8. The method of claim 1, wherein refraining from communicating with the one or more satellites comprises:
transitioning to a sleep state until the at least one alignment opportunity of the one or more alignment opportunities.

9. The method of claim 1, wherein determining the one or more alignment opportunities comprises:
determining one or more first alignment opportunities associated with the one or more satellites;
detecting movement of the wireless communication device before the one or more first alignment opportunities; and
determining one or more second alignment opportunities associated with the one or more satellites based on the movement of the wireless communication device.

10. The method of claim 1, further comprising:
determining whether or not communication with the at least one satellite was successful.

11. The method of claim 10, wherein:
communicating with the at least one satellite comprises transmitting a message to the at least one satellite, and
the message is determined to have been transmitted successfully based on reception of an acknowledgment from the at least one satellite.

12. The method of claim 10, further comprising:
notifying a user of the wireless communication device whether or not communication with the at least one satellite was successful.

13. The method of claim 10, further comprising:
re-attempting to communicate with the at least one satellite based on communication with the at least one satellite being unsuccessful.

14. The method of claim 1, further comprising:
prompting a user of the wireless communication device to place the wireless communication device on a stable surface such that a main lobe of at least one of the one or more antennas faces upward.

15. The method of claim 1, further comprising:
determining that the wireless communication device is not stationary;
determining a pattern of movement of the wireless communication device; and
increasing a margin of error of the one or more alignment opportunities based on the pattern of movement.

16. The method of claim 1, further comprising:
notifying a user of the wireless communication device of a time of a next alignment opportunity of the one or more alignment opportunities.

17. The method of claim 1, further comprising:
monitoring a signal strength of the at least one satellite before communication with the at least one satellite,
wherein communication with the at least one satellite is based on the signal strength of the at least one satellite being above a threshold.

18. The method of claim 1, wherein detecting the trigger comprises:
receiving a request from a user of the wireless communication device to communicate via satellite connectivity;
detecting an emergency event at the wireless communication device;
determining that the user is incapable of performing an interactive pointing procedure with the wireless communication device; or
any combination thereof.

19. The method of claim 18, further comprising:
displaying a prompt to the user to choose to perform the interactive pointing procedure or the method of wireless communication,
wherein the user is determined to be incapable of performing the interactive pointing procedure based on reception of user input to perform the method of wireless communication.

20. The method of claim 18, further comprising:
detecting a plurality of failed attempts to perform the interactive pointing procedure,
wherein the user is determined to be incapable of performing the interactive pointing procedure based on the plurality of failed attempts being detected.

21. The method of claim 1, wherein:
communicating with the at least one satellite comprises transmitting at least one first message to the at least one satellite,
communicating with the at least one satellite comprises receiving at least one second message from the at least one satellite, or
any combination thereof.

22. The method of claim 1, wherein the wireless communication device is:
an Internet of Things (IoT) device, or
a wireless communications device.

23. The method of claim 1, wherein the trigger to communicate via satellite connectivity is based on the wireless communication device not having cellular connectivity.

24. A wireless communication device, comprising:
one or more memories;
one or more transceivers; and
one or more processors communicatively coupled to the one or more memories and the one or more transceivers, the one or more processors, either alone or in combination, configured to:
detect a trigger to communicate via satellite connectivity;
determine one or more alignment opportunities associated with one or more satellites, wherein each alignment opportunity of the one or more alignment opportunities is a time period during which a main lobe of at least one antenna of one or more antennas of the wireless communication device is predicted to be aligned with a line-of-sight (LOS) direction to at least one of the one or more satellites;
refrain from communicating with the one or more satellites until at least one alignment opportunity of the one or more alignment opportunities; and
communicate, via the one or more transceivers, with at least one satellite of the one or more satellites during the at least one alignment opportunity of the one or more alignment opportunities.

25. The wireless communication device of claim 24, wherein the one or more alignment opportunities are determined based on:
a characterization of an orientation and shape of each main lobe of each of the one or more antennas relative to the wireless communication device,
an estimate of an orientation of the wireless communication device relative to the Earth,
an estimate of an uncertainty of the orientation of the wireless communication device,
an estimate of trajectories of the one or more satellites,
signal strength measurements of the one or more satellites,
one or more preferences related to selecting the one or more satellites, or
any combination thereof.

26. The wireless communication device of claim 25, wherein the orientation of the wireless communication device relative to the Earth comprises a gravity direction only.

27. The wireless communication device of claim 24, wherein the one or more processors, either alone or in combination, are further configured to:
determine whether an orientation of the wireless communication device is stable.

28. The wireless communication device of claim 27, wherein the one or more processors, either alone or in combination, are further configured to:
initiate an orientation change detector based on the orientation of the wireless communication device being stable; or
prompt a user of the wireless communication device to place the wireless communication device on a stable surface based on the orientation of the wireless communication device not being stable.

29. The wireless communication device of claim 28, wherein the wireless communication device communicates with the at least one satellite during the at least one alignment opportunity of the one or more alignment opportunities based on the orientation change detector not detecting a change in the orientation of the wireless communication device.

30. The wireless communication device of claim 24, wherein the one or more processors, either alone or in combination, are further configured to:
determine that the one or more alignment opportunities will not occur within a threshold period of time of a current time; and
prompt a user of the wireless communication device to reposition the wireless communication device.

31. The wireless communication device of claim 24, wherein the one or more processors configured to refrain from communicating with the one or more satellites comprises the one or more processors, either alone or in combination, configured to:
transition to a sleep state until the at least one alignment opportunity of the one or more alignment opportunities.

32. The wireless communication device of claim 24, wherein the one or more processors configured to determine the one or more alignment opportunities comprises the one or more processors, either alone or in combination, configured to:
determine one or more first alignment opportunities associated with the one or more satellites;
detect movement of the wireless communication device before the one or more first alignment opportunities; and
determine one or more second alignment opportunities associated with the one or more satellites based on the movement of the wireless communication device.

33. The wireless communication device of claim 24, wherein the one or more processors, either alone or in combination, are further configured to:
determine whether or not communication with the at least one satellite was successful.

34. The wireless communication device of claim 33, wherein:
communicating with the at least one satellite comprises transmitting a message to the at least one satellite, and
the message is determined to have been transmitted successfully based on reception of an acknowledgment from the at least one satellite.

35. The wireless communication device of claim 33, wherein the one or more processors, either alone or in combination, are further configured to:
notify a user of the wireless communication device whether or not communication with the at least one satellite was successful.

36. The wireless communication device of claim 33, wherein the one or more processors, either alone or in combination, are further configured to:
re-attempt to communicate with the at least one satellite based on communication with the at least one satellite being unsuccessful.

37. The wireless communication device of claim 24, wherein the one or more processors, either alone or in combination, are further configured to:
prompt a user of the wireless communication device to place the wireless communication device on a stable surface such that a main lobe of at least one of the one or more antennas faces upward.

38. The wireless communication device of claim 24, wherein the one or more processors, either alone or in combination, are further configured to:
determine that the wireless communication device is not stationary;
determine a pattern of movement of the wireless communication device; and
increase a margin of error of the one or more alignment opportunities based on the pattern of movement.

39. The wireless communication device of claim 24, wherein the one or more processors, either alone or in combination, are further configured to:
notify a user of the wireless communication device of a time of a next alignment opportunity of the one or more alignment opportunities.

40. The wireless communication device of claim 24, wherein the one or more processors, either alone or in combination, are further configured to:
monitor a signal strength of the at least one satellite before communication with the at least one satellite,
wherein communication with the at least one satellite is based on the signal strength of the at least one satellite being above a threshold.

41. The wireless communication device of claim 24, wherein the one or more processors configured to detect the trigger comprises the one or more processors, either alone or in combination, configured to:
receive, via the one or more transceivers, a request from a user of the wireless communication device to communicate via satellite connectivity;
detect an emergency event at the wireless communication device;
determine that the user is incapable of performing an interactive pointing procedure with the wireless communication device; or
any combination thereof.

42. The wireless communication device of claim 41, wherein the one or more processors, either alone or in combination, are further configured to:
display a prompt to the user to choose to perform the interactive pointing procedure or the method of wireless communication,
wherein the user is determined to be incapable of performing the interactive pointing procedure based on reception of user input to perform the method of wireless communication.

43. The wireless communication device of claim 41, wherein the one or more processors, either alone or in combination, are further configured to:
detect a plurality of failed attempts to perform the interactive pointing procedure,
wherein the user is determined to be incapable of performing the interactive pointing procedure based on the plurality of failed attempts being detected.

44. The wireless communication device of claim 24, wherein:
communicate, via the one or more transceivers, with the at least one satellite comprises transmitting at least one first message to the at least one satellite,
communicate, via the one or more transceivers, with the at least one satellite comprises receiving at least one second message from the at least one satellite, or
any combination thereof.

45. The wireless communication device of claim 24, wherein the wireless communication device is:
an Internet of Things (IoT) device, or
a wireless communications device.

46. The wireless communication device of claim 24, wherein the trigger to communicate via satellite connectivity is based on the wireless communication device not having cellular connectivity.

47. A wireless communication device, comprising:
means for detecting a trigger to communicate via satellite connectivity;
means for determining one or more alignment opportunities associated with one or more satellites, wherein each alignment opportunity of the one or more alignment opportunities is a time period during which a main lobe of at least one antenna of one or more antennas of the wireless communication device is predicted to be aligned with a line-of-sight (LOS) direction to at least one of the one or more satellites;
means for refraining from communicating with the one or more satellites until at least one alignment opportunity of the one or more alignment opportunities; and
means for communicating with at least one satellite of the one or more satellites during the at least one alignment opportunity of the one or more alignment opportunities.

48. A non-transitory computer-readable medium storing computer-executable instructions that, when executed by a wireless communication device, cause the wireless communication device to:
detect a trigger to communicate via satellite connectivity;
determine one or more alignment opportunities associated with one or more satellites, wherein each alignment opportunity of the one or more alignment opportunities is a time period during which a main lobe of at least one antenna of one or more antennas of the wireless communication device is predicted to be aligned with a line-of-sight (LOS) direction to at least one of the one or more satellites;
refrain from communicating with the one or more satellites until at least one alignment opportunity of the one or more alignment opportunities; and
communicate with at least one satellite of the one or more satellites during the at least one alignment opportunity of the one or more alignment opportunities.
